(19) United States
(12) Patent Application Publication
(10) Pub. No.: US 2007/0195728 A1
(43) Pub. Date: Aug. 23, 2007

(54) Automated method for constructing a routing infrastructure in an ad-hoc network

(76) Inventors: Shiwen Chen, Marlboro, NJ (US); Hongbing Li, Belle Mead, NJ (US); King Huang, East Brunswick, NJ (US); Harumine Yoshiba, Kanagawa-ken (JP); Kou Chu Lee, Princeton Junction, NJ (US); Jingxuan Liu, Laurel, MD (US)

Correspondence Address: GREGORY A. STOBBS, 5445 CORPORATE DRIVE, SUITE 400, TROY, MI, 48098, US

(21) Appl. No.: 11/357,810

(22) Filed: Feb. 17, 2006

(51) Int. Cl. H04Q 7/00

(52) U.S. Cl. 370/328

(57) ABSTRACT

A method is provided for mobile wireless ad hoc network, where network nodes using the same routing protocol are uniformly sharing a single contention channel. Network nodes are able to dynamically and distributedly switch roles according to surrounding network environment so that routing functions can be either activated or de-activated in order to improve routing efficiency and increase network capacity by reducing unnecessary routing overhead (which is caused by excessive redundant routing nodes). In addition, the nodes are able to self organize themselves into hierarchies or different roles according to different routing strategies. The proposed role-switching method can be implemented on network nodes which support existing routing protocols or native routing protocol proposed herein to further exploit the proposed role-switching method.

### FIELD

The present disclosure relates to an automated method for constructing a routing infrastructure in an ad hoc network and a routing protocol tailored for use with the constructed routing infrastructure.

### BACKGROUND

A wireless mobile ad-hoc network usually consists of multiple computer devices that need to establish communications among themselves with no special equipment deployed, and no wires connecting each other to facilitate the mobility of these devices. To facilitate communications, wireless communication components are installed on these devices.

A typical example of such network would be several laptop computers that are close to each other. Each computer is equipped with one wireless communication adapter (e.g. using IEEE 802.11b standard). For instance, the IEEE 802.11 standard only provides data link layer communication so that it is possible for two wireless devices to communicate with each other when they are close enough to be in each other's radio coverage area.

When a device needs to communicate with another device that is out of its radio coverage, it is possible that data can be relayed if some other devices are in between the two devices. Such routing is usually referred to as ad hoc routing or mobile ad hoc network (MANET) routing. One of the issues for ad hoc routing is that the performance and efficiency is difficult to maintain when such ad hoc network is populated with a dense quantity of ad hoc nodes, due to overwhelming media/channel contentions in the network.

Although sometimes it is easier to manage when using different types of nodes with different link layer access protocols and different physical band channels, it is still difficult in a large and dense network of homogeneous nodes with the same capabilities: the nodes use the same physical channel and radio band, use same link layer contention-based access protocol (such as CSMA based 802.11), and use a same network layer routing protocol.

Furthermore, sometimes the mobility requirement does not allow nodes easily be clustered into groups where a group member can only access the group leader or cluster header (and usually, use TDMA based link layer access protocol instead of CSMA based protocol such as 802.11). In this case, it is desirable to construct a self-organizing routing infrastructure for the devices in the network by dynamically assigning these equal nodes into different hierarchical roles of routing function to adapt to network condition and environmental changes over time, so that network overhead is controlled and reduced, while performance and efficiency is improved.

The statements in this section merely provide background information related to the present disclosure and may not constitute prior art.

### SUMMARY

A method is provided for improving routing efficiency in a mobile ad hoc network. The method includes: providing a plurality of nodes for use in the network, where each node is configured for wireless communication with other nodes using the same media contention scheme to access the same channel of the network and is capable of activating routing functions or deactivating routing functions associated with the node; assigning a routing role to each node in the network by either activating routing functions or deactivating routing functions of the node; and dynamically switching routing roles of the nodes in the network over time according to network conditions.

Further areas of applicability will become apparent from the description provided herein. It should be understood that the description and specific examples are intended for purposes of illustration only and are not intended to limit the scope of the present disclosure.

### DRAWINGS

FIG. 1 is a diagram of an exemplary deployment scenario for a wireless ad hoc network;

FIG. 2 is a flowchart illustrating an exemplary probing procedure for constructing a routing infrastructure in an ad hoc network;

FIG. 3 is a flowchart illustrating an exemplary nomination procedure that cooperatively works with the probing procedure to construct the routing infrastructure;

FIG. 4 is a flowchart illustrating an alternative procedure for constructing a routing infrastructure;

FIG. 5 is a diagram of an architecture for implementing these procedures on a node of the network.

The drawings described herein are for illustration purposes only and are not intended to limit the scope of the present disclosure in any way.

### DETAILED DESCRIPTION

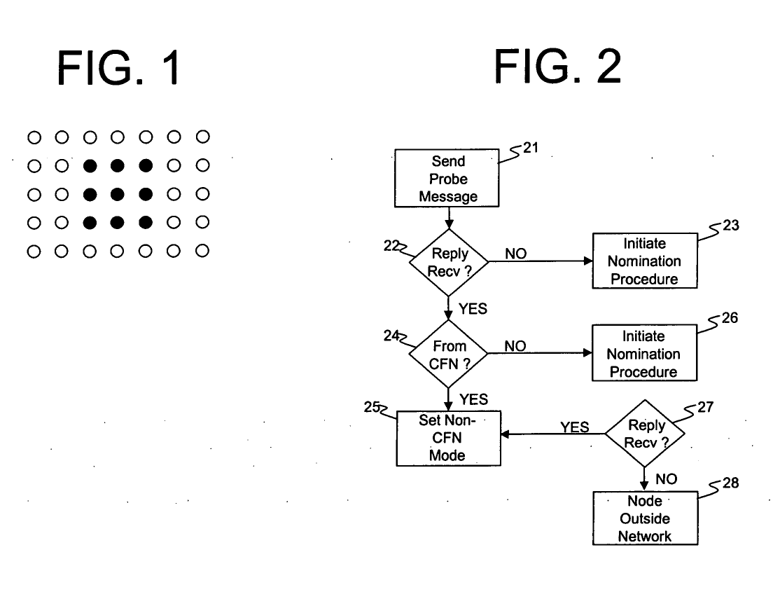

An exemplary deployment scenario for a wireless ad hoc network could be a grid network of 35 nodes as shown in FIG. 1. In this example, the network covers an area of 300 m by 200 m. Network nodes are deployed 50 meters apart. Each network node is configured for wireless communication with the other nodes. In an exemplary embodiment, the network nodes are configured to communicate using the same media contention scheme (e.g., CMSA) to access the same channel in the same radio band. However, a single node radio interference area can cover many nodes (e.g. ¼ to ⅓ of the nodes in the whole network).

Given the ad-hoc nature of the network, a routing infrastructure is established by assigning nodes into one of the following 2 modes: a candidate forwarding node (CFN) mode, or a non-forwarding node which is referred to as a non-CFN mode. When a node is set to be in CFN mode, it shall activate all of its routing functions as provided by a routing protocol. In addition, it may need to do other operations in order to maintain the routing infrastructure. Thus, the designated CFN nodes form an ad-hoc routing array (ARA) to serve the routing needs in the wireless ad-hoc network.

Conversely, when a node is set to a non-CFN mode, the node only uses a subset of the functions of the routing protocol. These functions basically support the communication needs for the node itself. For example, sending and receiving data, maintain minimal routing information, and executing exchanges with CFN nodes so that packets (either to or from the non-CFN node) can be delivered successfully. Although these basic functions continue to be provided by a non-CFN node, for purposes of this disclosure a non-CFN is assumed to have deactivated its routing functions.

Two software-implemented procedures for constructing a routing infrastructure are further described below. A first procedure for constructing a routing infrastructure is intended to meet the following two criteria: all CFN nodes are within N-2 hops from each other, where N is a number of maximum radio hops for a given network; and any non-CFN node is within a single hop of a CFN node. Although a particular CFN node is not required to be static, the group of CFN nodes are preferably static relative to the non-CFN nodes so that these two requirements remain satisfied during an assignment period.

The routing infrastructure can be established recursively when nodes join together to form an ad-hoc network. When joining the network, a node initiates a probing procedure to resolve routing assignments. The probing procedure enables a node to learn the surrounding topology, determine which role the node shall be assigned and, when necessary, initiate a nomination procedure either locally or in neighboring nodes, where the nomination process determines whether to activate the routing functions of a nominated node.

FIG. 2 illustrates an exemplary probing procedure. The probing procedure begins by sending a probing message at 21 to neighboring nodes in the network. In other words, the probing message is limited to a single hop (i.e., time-to-live parameter set to one). The probing node then awaits a reply message in response to the probing message. If no reply messages are received within a defined period of time, then the probing node will locally initiate a nomination process as shown at 23. This nomination process will be further described below.

When a reply message is received, the probing node assesses whether the reply message was sent from a CFN node or a non-CFN node as indicated at 24. If a reply message was sent from at least one CFN node, then the probing node sets itself at 25 as a non-CFN node. Conversely, if a reply message was received only from non-CFN nodes, then the probing node initiates the nomination process at 26 in each of these neighboring non-CFN nodes. To do so, an activation message is sent from the probing node to each of these nominated nodes. The probing node again awaits a response from the nominated nodes.

Successful completion of the nomination process results in the nominated node being re-assigned to a CFN mode. If a probing node receives a successful response from at least one of the nominated nodes, then the probing node sets itself at 25 as a non-CFN node. On the other hand, if the probing node does not receive a successful response, then the probing node is considered outside the scope of the network as indicated at 28.

During the nomination process, a nominated node proposes that it become a CFN node. A proposal message is broadcasted from the nominated node to nodes proximate thereto. For instance, the proposal message is sent with a random waiting time and a hop count set to N. If the proposal is rejected (i.e., by receiving at least one proposal rejection message), then the nominated node remains in a non-CFN mode. However, if the proposal is not rejected within a sufficiently long period of time, then the proposal has been accepted by proximate nodes and the nominated node sets itself to a CFN mode. It is noteworthy that during the nomination process, the nominated node considers itself a CFN node and thus will forward messages received from other nodes.

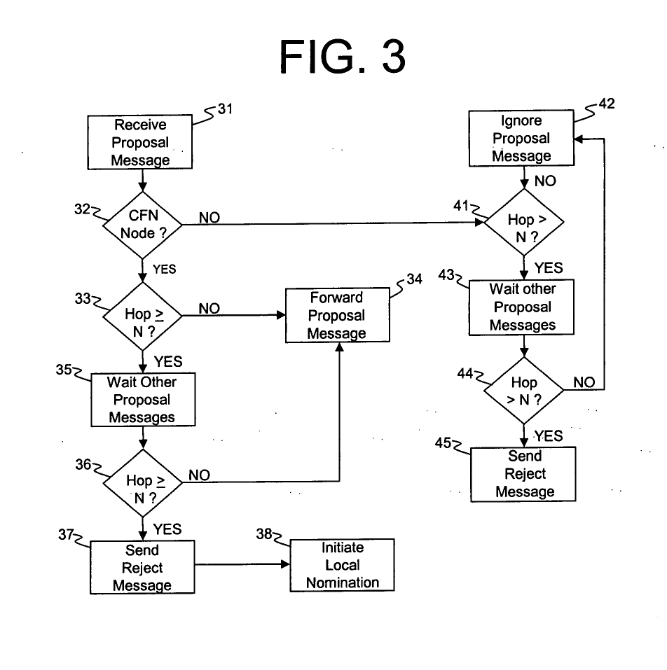

FIG. 3 illustrates the process by which proposal messages are handled by proximate nodes. Upon receipt of a proposal message at 31, a receiving node will assess its current routing mode at 32. When the receiving node is in a CFN mode, it will further assess the hop count traveled by the proposal message at 33. When the hop count is less than N, the receiving node will forward the proposal message to neighboring nodes and ignore any subsequent proposal messages from the same source as indicated at 34. When the hop count is greater than or equal to N, the receiving node will wait for other proposal messages coming from the same source as indicate at 35. If at least one proposal message arrives within the waiting period with a hop count less than N, the receiving node will forward the proposal message to neighboring nodes and ignore any subsequent proposal messages from the same source. If all of the received proposal messages have a hop count greater or equal to N, then a message rejecting the proposal is sent at 37 from the receiving node to the proposing node. Because the topology of the network may have changed, this rejecting node will also schedule itself at 38 to run the nomination process.

Likewise, when the receiving node is in a non-CFN mode, it will assess the hop count traveled by the proposal message at 41. When the hop count is less than or equal to N, the receiving node will ignore the proposal message as indicated at 42. When the hop count is greater than N, the receiving node will wait for other proposal messages coming from the same source as indicate at 43. If at least one proposal message arrives within the waiting period with a hop count less than or equal to N, the receiving node will ignore each of the proposal messages. However, if all of the received proposal messages have a hop count greater or equal to N, then a message rejecting the proposal is sent at 45 from the receiving node to the proposing node.

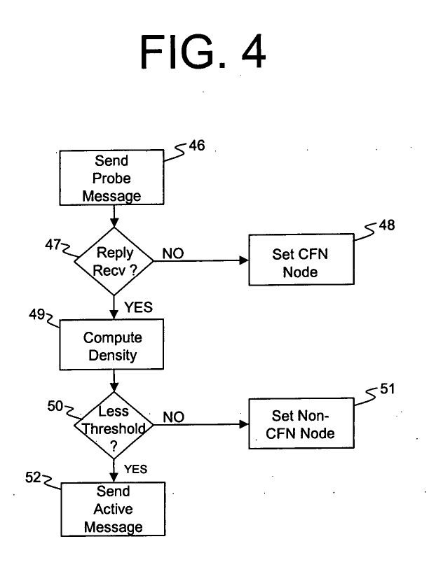

With reference to FIG. 4, a second procedure for constructing a routing infrastructure is designed to distribute CFN nodes within a given density constraint. The procedure begins by sending a probing message at 46 to neighboring nodes in the network. The probing node then awaits a reply message in response to the probing message. If no reply messages are received within a defined period of time, then the probing node will set itself at 48 in a CFN mode.

When reply messages are received by the probing node, it will compute a density measure at 49 of nodes which provide routing functions (i.e., in CFN mode) proximate to the probing node. The density measure is computed as m/(m+n), where m is the number of reply messages from CFN nodes and n is the number of reply messages from non-CFN nodes. If the density measure is greater than or equal to a target density threshold, then the probing node is set at 51 in a non-CFN mode. Conversely, if the density measure is less than the target threshold, then the probing node send an activation message at 52 to its neighbor nodes. In response to the activation message, neighboring nodes will set themselves to a CFN mode, thereby increasing the density metric in the area proximate to the probing node.

This second procedure may be further modified to ensure that non-CFN nodes can directly reach at least one CFN node. Upon completing the process described above, the probing node starts a timer having a randomly distributed duration. When the timer expires, the probing node restarts the probing process. If the probing node intends to switch from a CFN mode to a non-CFN mode as a result of the probing process, it will first broadcast a message indicating to the same to its immediate neighboring nodes. If any one of the neighboring nodes is unaware of another CFN node, then a message is sent back to the probing node requesting that it remains in CFN mode. In this way, each non-CFR node is able to directly reach at least one CFN node.

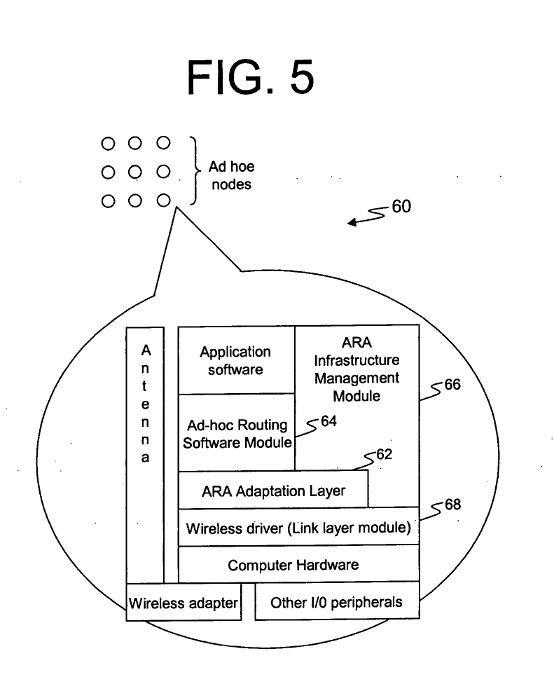

Each node is configured to implement one or more of these self-organizing procedures as shown in FIG. 5. An adaptation layer 62 is introduced between the routing software module 64 and the wireless driver 68 residing in the link layer of the network node. In general, the adaptation layer 62 is operable to filter certain routing messages sent to and received from the network. In addition, the adaptation layer 62 can interpret routing messages received from the network as well as cooperatively work with a routing infrastructure management module 66 as further described below.

In an exemplary embodiment, the routing software module 64 implements the LUNAR routing protocol. When a node is set to the CFN mode, the adaptation layer 62 will pass all routing messages from the network to the routing software module. The routing software module 64 will in turn process the messages in accordance with the LUNAR routing protocol. In contrast, when the node is set to the non-CFR mode, all routing messages are discarded by the adaptation layer unless the message is addressed to the node itself or originated from the node itself from upper layer applications. It is readily understood that this architecture can be implemented with other routing protocols such as AODV, DSR, etc.

A routing infrastructure management module 66 is responsible for managing and maintaining a routing infrastructure (e.g. assigning CFN nodes), and communicating with the adaptation layer or the routing protocol to, for example, enable or disable certain routing functionality of the node. This management module 66 provides a user interface to the network administrator, who should be able to initiate autonomous CFN assignment procedure, review automated CFN assignment results, or assign/un-assign CFN nodes manually. Furthermore, the automated self-organizing procedures described above are implemented by the infrastructure management module.

After an initial assignment of CFN or non-CFN nodes, the infrastructure management module 66 may have choices to maintain the CFN infrastructure actively or passively. If the management module 66 is set to maintain the CFN actively, CFN nodes may repeat a self-organizing procedure periodically. In addition, non-CFN nodes may keep on sensing the existence of CFN nodes, if all its CFN neighbors are lost, it shall start the self-organizing procedures immediately.

On the other hand, if the infrastructure management module 66 is set to passively maintain the CFN infrastructure, usually to avoid applying extra overhead to the ad-hoc network, it may depend on notifications from the routing protocol module 64 and/or the adaptation layer module 62 for any potential topology changes. If the adaptation layer module 62 or the routing protocol modules 64 detects that a non-CFN node can no longer find a CFN node, it may notify the infrastructure management module to initiate the self-organizing procedure.

An exemplary control message scheme for implementing the automated self-organizing procedures is also provided. Generally, each control message contains a header and a message body, which is different for different types of messages. In an exemplary embodiment, the control messages are directly embedded in Ethernet frames. Further details regarding the control message scheme are found in appendix below.

In another aspect of this disclosure, a routing protocol that is particularly tailored for use with the resulting routing infrastructure is further described below. In general, the protocol relies upon announcement messages to learn the topology of the network. Announcement messages are periodically sent from a CFN node. These messages serve to inform neighboring nodes as to its existence as well as inform other nodes which non-CFN nodes are registered with the announcing node. Information encapsulated in announcement messages is in turn used to construct and maintain routing information amongst the different nodes of the network.

For example, a list of routing nodes is maintained at each node. At CFN nodes, the list includes all of the currently designated CFN nodes in the network. At non-CFN nodes, the list only includes CFN nodes that are neighbors to the node. In either case, MAC addresses of the CFN nodes are recorded in the list of nodes.

In addition, each non-CFN node shall choose one neighboring CFN node as its destination-side forwarding node (DFN). In an exemplary embodiment, a non-CFN node picks the CFN node having the best link quality with the selecting non-CFN node. Although other means are contemplated, the link quality with a neighboring node may be assessed though interaction with the WiFi driver. Once a CFN node is selected as the DFN, a registration message is sent from the registering non-CFN node to the CFN node.

Upon receipt of a registration message, the CFN node will update a list of registered nodes which is herein referred to as a DFN table. A DFN table is maintained at each CFN node and is required to include entries for each of the non-CFN nodes in the network. To propagate this information through the network, the CFN will also immediately send a new announcement message. If a node fails to register with a CFN node (e.g., due to asymmetric link quality), the node may choose another CFN as its DFN.

Each node is further operable to sense the link quality with its neighboring nodes. When a node detects its chosen DFN has a link quality below a predefined threshold and another neighboring CFN node has a link quality higher than the threshold, this node will send a registration message to the newly selected DFN node. The newly selected DFN node will likewise send an announcement message.

Each node will also maintain a list of source side forwarding (SFN) nodes. Entries in this list will include: at least one neighboring node designated as the default SFN node; other neighboring nodes whose link quality is estimated to be higher than a predefined threshold; and non-CFN nodes within two hops of the source node. The source node selects one neighboring node having the best link quality as the default SFN node. Although the DFN is used as the default SFN, a source node need not select the DFN node as the default SFN node. This list is referred to herein as a SFN table.

When an application requests that data be sent, a source node looks up the destination of the data in the SFN table. If an entry in the table matches the destination, the data packets are forwarded directly to the destination node. If no entry is found in the table, then the data packets are forwarded to the default SFN node. A timer is associated with each entry in the SFN table so that when the non-CFN node does not hear from a particular node any more, it will not attempt to send packets to this node directly.

If a node senses a neighbor non-CFN, it knows the link quality from this neighbor to itself. If the respective link quality to this neighbor is over the requisite threshold, it may be used as a heuristic of the link quality to this neighbor, so that direct one hop communication can be attempted. Later we will discuss more about how to switch from 1-hop to multi-hop when the link is asymmetric.

If a node hears an announcement message, it first looks at the list of registered nodes reported in the announcement message. For these registered nodes, this announcing CFN is actually the DFN for them. Therefore, the node who hears this announcement message shall always use this CFN as SFN when sending packets to these nodes who registered themselves with this CFN.

An announcement message may also include some other nodes that may not be registered with this announcing node. In this case, if the link quality included in the announcement message is over the requisite threshold, it may be considered by receiving non-CFN nodes as a heuristic for using the announcing CFN as the SFN to those nodes. This is one way to fill the SFN table at some non-CFN nodes, when they hear from the announcing CFN directly.

In operation, data packets may be received at a CFN node or a non-CFN node of the ad hoc network. When data packets are received at a CFN node, the node inquires as to whether the packet is addressed to one of its neighboring nodes. If the data packets are intended for a neighboring node, then CFN node forwards the data packets directly to the destination node. If the data packets are no intended for a neighboring node, then the CFN node forwards the data packets in accordance with the DFN table. On the other hand, when a non-CFN node receives data packets that are not address to it, the data packets are discarded. In any case, when a node receives data packets that are addressed to it, the node will process the data packets accordingly.

A source node always tries to sense its neighbors and uses short paths whenever possible. When using a shortcut path, a source node monitors the link quality to the next hop (i.e., the destination in 1-hop route and the SFN in 2-hop route). If the link is not usable, the source node will send its packets to its default SFN. Similarly, if the SFN for a two hop route is not the DFN for the destination and the loss ratio is high, the source node shall redirect the data packets to the destination's DFN. Such high loss ratio links should be remembered so that the source node can avoid repeatedly trying them. To avoid switching back to this inferior link later (for shortest path purpose), the source records the signal strength level. Until there is a significant increase of the link quality, the source node will avoid use of this link.

When a non-CFN node sees three consecutive announcement messages from a CFN node without seeing any announcements from its selected DFN's node, it is considered DFN loss. This allows a non-CFN node to detect a DFN loss within approximately 2 seconds. When DFN loss happens, the detecting non-CFN node shall register to another CFN. An alternative approach is maintaining a timer (e.g. 1.2 seconds), if an announcement fails to be heard from the DFN node, the DFN is considered lost. This may further shorten the loss detection time.

Strictly speaking, the concept of “path” is not used in this routing protocol. Packets may be delivered dynamically along different paths during a session. One factor that causes packets to be delivered along different paths is the SFN table. A source node continually senses the surrounding environment to enable 1-hop and 2-hop delivery. Meanwhile, it keeps on monitoring the transmission quality so that a SFN can be changed if the 1-hop or 2-hop transmission quality is not satisfying. Similarly, a SFN also keeps on updating its neighbor list by sensing the surrounding media. Also, it keeps on monitoring the delivery quality to a 2-hop destination so that it may decide to switch to the destination's DFN when necessary.

Destination loss can be detected only when the DFN forwards data packets to the destination. When DFN detects such link failure, a new announcement message shall be sent immediately, so that other nodes can be updated. Because this event happens during transmission of data for a session, it may trigger the destination search procedure later, when the SFN is updated about the destination loss.

Routing messages are encapsulated in a standard IP packet. Therefore, information such as packet source IP address or MAC address is not specified particularly in a routing message. A routing message may contain four bytes, where the first byte is the message type and the other bytes are reserved for now. In the IP header, a protocol number shall be specified for the routing protocol and shall not conflict with previously assigned IANA numbers.

The purpose of this routing protocol is to improve routing performance so that limited video transmissions can be better served in a quasi-static ad-hoc network. This protocol tries to be lightweight, with minimized traffic overhead for the assumed ad-hoc application network. In addition, this protocol improve throughput and delay performance, as well as fast link error recovery and avoidance due to link-independent nature. Although the exemplary implementation of the routing protocol described above employed a three hop limit, it is readily understood that the protocol could be extended to support a hop limit greater than three, for example, by extending the broadcast range of the nodes.

The above description is merely exemplary in nature and is not intended to limit the present disclosure, application, or uses. It is again noted that the method for constructing the routing infrastructure is not dependent on a particular routing protocol. Rather, it has been shown that existing routing protocols, such as LUNAR, can be customized for this infrastructure. Likewise, it is envisioned that the routing protocol may be employed with different routing infrastructures.

### Appendix

Control Message Header

The header may include the following information:

ARA node ID

infrastructure type:
first procedure described above (i.e., ARA-C): 1
second procedure described above (i.e., ARA-D): 2
second procedure with modification (i.e., ARA-Dt): 3

Message type:
ARA _PROBE
ARA_PROBE_REPLY
CFN _PROPOSE
CFN _PROPOSE_REJECT
CFN _ACTIVATE
CFN_ACTIVATE_REPLY
CFN_RETREAT
CFN_RETREAT_REJECT

Fields reserved for future use

Control Message Content

ARA PROBE

This message may contain the following content:

Probe range

Sequence number

Infrastructure formation specific information
For ARA-C: the network scope N
For ARA-D: the density D
For ARA-Dt: the refresh period t

Reserved bytes

ARA Probe Reply

This message may contain the following content:

destination ARA node ID (the sender of the CFN_PROBE regarding to this reply)

the ARA_PROBE Sequence number this message is regarding to

Role of the replying node: CFN or non-CFN

Ad-hoc routing protocol supported in the replying node

Infrastructure formation specific information
For ARA-C: the network scope N
For ARA-D: the density D
For ARA-Dt: the refresh period t

Reserved bytes

CFN Propose

This message may contain the following content:

TTL value

Sequence number

Ad-hoc routing protocol supported in the replying node

Infrastructure formation specific information
For ARA-C: the network scope N
ForARA-D: the density D
For ARA-Dt: the refresh period t

Reserved bytes

CFN Propose Reject

This message may contain the following content:

The CFN_PROPOSE Sequence number this message is regarding to

destination ARA node ID (the sender of the CFN_PROPOSE regarding to this reply)

Reject reason

Infrastructure formation specific information
For ARA-C: the network scope N
For ARA-D: the density D
For ARA-Dt: the refresh period t

Reserved bytes

CFN Activate

This message may contain the following content:

destination ARA node ID

Ad-hoc routing protocol to be used

Infrastructure formation specific information
For ARA-D: number of CFN nodes (m), number of non-CFN nodes (n), etc.
For ARA-C: the network scope N
For ARA-D: the density D
ForARA-Dt: the refresh period t

Reserved bytes

CFN Activate Reply

This message may contain the following content:

The CFN_ACTIVATE Sequence number this message is regarding to

destination ARA node ID (the sender of the CFN_ACTIVATE regarding to this reply)

Status information:
Success or failure
Failure reason

Infrastructure formation specific information
For ARA-C: the network scope N
For ARA-D: the density D
For ARA-Dt: the refresh period t

Reserved bytes

CFN Retreat

This message may contain the following content:

Sequence number

Infrastructure formation specific information
For ARA-C: the network scope N
For ARA-D: the density D
For ARA-Dt: the refresh period t

Reserved bytes

CFN Retreat Reject

This message may contain the following content:

The CFN_RETREAT Sequence number this message is regarding to

destination ARA node ID (the sender of the CFN_RETREAT regarding to this reply)

Infrastructure formation specific information
For ARA-C: the network scope N
For ARA-D: the density D
For ARA-Dt: the refresh period t

Reserved bytes

What is claimed is:

1. A method for improving routing efficiency in a mobile ad hoc network, comprising:
providing a plurality of nodes for use in the network, where each node is configured for wireless communication with other nodes using the same media contention scheme to access the same channel of the network and capable of activating routing functions or deactivating routing functions associated with the node;
assigning a routing role to each node in the network by either activating routing functions or deactivating routing functions of the node; and
dynamically switching routing roles of the nodes in the network over time according to network conditions.

2. The method of claim 1 further comprises routing any incoming data packets at a given node when the routing functions of the given node are activated and routing only incoming data packets addressed to the given node when the routing functions of the given node are deactivated.

3. The method of claim 2 further comprises ignoring incoming data packets which are not addressed to the given node when the routing functions of the given node are deactivated.

4. The method of claim 1 wherein assigning a routing role to each node further comprises:
learning routing capabilities of neighboring nodes by a given node, where the neighboring nodes are within a wireless communication range of the given node;
initiating a nomination process in each of the neighboring nodes when the routing functions of all neighboring nodes are presently inactive, wherein the nomination process determines whether to activate the routing functions of a nominated node; and
deactivating routing functions of the given node when the routing functions of at least one of the neighboring nodes is presently active.

5. The method of claim 1 wherein assigning a routing role to each node further comprises:
learning routing capabilities of nodes in an area proximate to a given node in the network;
activating routing functions of the given node when nodes having routing functions in the area proximate to the given node is less than a density constraint, where the density constraint defines a target percentage of nodes that are to provide routing functions in the network; and
deactivating the routing functions of the given node when nodes having routing functions in the area is not less than the density constraint.

6. A software-implemented method for constructing a routing infrastructure from amongst a plurality of nodes in an ad hoc network, comprising:
learning routing capabilities of neighboring nodes by a given node, where the neighboring nodes are within a wireless communication range of the given node;
initiating a nomination process in each of the neighboring nodes when the routing functions of all neighboring nodes are presently inactive, wherein the nomination process determines whether to activate the routing functions of a nominated node; and
deactivating routing functions of the given node when the routing functions of at least one of the neighboring nodes is presently active.

7. The method of claim 6 wherein learning routing capabilities further comprises broadcasting a request message from the given node to neighboring nodes within its communication range; and receiving a reply message in response to the request message from the neighboring nodes, where the reply message indicates whether routing functions of the responding node are active.

8. The method of claim 6 wherein the nomination process includes broadcasting a proposal message from the nominated node to other nodes in the network; and activating the routing functions of the nominated node unless a proposal reject message is received by the nominated node within a period of time.

9. The method of claim 8 further comprises deactivating the routing functions of the nominated node when a proposal reject message is received by the nominated node.

10. The method of claim 8 further comprises forwarding the proposal message to nodes which are one hop further away from the nominated node than a maximum number of hops as specified by a routing protocol governing the network.

11. The method of claim 8 further comprises sending a proposal reject message to the nominated node from a responding node which receives the proposal message, when the routing functions of the responding node are active and the proposal message indicates a hop count from the nominated node which is equal or greater than a maximum number of hops as specified by a routing protocol governing the network.

12. The method of claim 11 further comprises sending the proposal reject message from the responding node when another proposal message having a hop count less than the maximum number of hops is not received by the responding node within a period of time.

13. The method of claim 11 further comprises scheduling a nomination process for the responding node subsequent to sending the proposal reject message.

14. The method of claim 8 further comprises sending a proposal reject message to the nominated node from a responding node which receives the proposal message, when the routing functions of the responding node are inactive and the proposal message indicates a hop count from the nominated node which is greater than a maximum number of hops as specified by a routing protocol governing the network.

15. The method of claim 11 further comprises sending the proposal reject message from the responding node when another proposal message having a hop count less than the maximum number of hops is not received by the responding node within a period of time.

16. A software-implemented method for constructing a routing infrastructure from amongst a plurality of nodes in an ad hoc network, comprising:
learning routing capabilities of nodes in an area proximate to a given node in the network;
activating routing functions of the given node when nodes having routing functions in the area proximate to the given node is less than a density constraint, where the density constraint defines a target percentage of nodes that are to provide routing functions in the network; and
deactivating the routing functions of the given node when nodes having routing functions in the area is not less than the density constraint.

17. The method of claim 16 wherein learning routing capabilities further comprises broadcasting a request message from the given node to nodes in the area proximate thereto; and receiving a reply message in response to the request message from the nodes in the area, where the reply message indicates whether routing functions of the responding node are active.

18. The method of claim 16 further comprises sending a message requesting activation of routing functions from the given node to the nodes having inactive routing functions when the nodes having routing functions in the area proximate to the given node is less than a density constraint.

19. The method of claim 16 further comprises activating the routing functions of the given node upon receipt of a message requesting activation of routing functions from another node in the network.

20. The method of claim 16 further comprises sending a reply message that indicates whether the functions of the given node are active upon receipt of a message requesting such information from another node in the network.

21. The method of claim 16 further comprises initiating a timer by the given node; and repeating the method for constructing a routing infrastructure upon expiration of the timer.

22. The method of claim 16 further comprises sending a message from the given node to neighboring nodes of the given node when the given node is deactivating its routing functions from an active state; and re-activating routing functions of the given node when a node in receipt of said message is not aware of another node having routing functions in an active state.
